(19) United States
(12) Patent Application Publication
(10) Pub. No.: US 2008/0050092 A1
(43) Pub. Date: Feb. 28, 2008

(54) Video overlay text/ graphic inserter for exception video trigger

(76) Inventor: Forrest Lee Erickson, Maryville, TN (US)

Correspondence Address: Forrest Lee Erickson, 3433 Ridgeway Trail, Maryville, TN, 37801, US

(21) Appl. No.: 11/891,242

(22) Filed: Aug. 10, 2007

Related U.S. Application Data
(60) Provisional application No. 60/840,185, filed on Aug. 25, 2006.

(51) Int. Cl. H04N 5/91

(52) U.S. Cl. 386/95; 386/E05.025

(57) ABSTRACT

A device for overlay of text or graphics onto video to trigger video recording on a motion sensitive video recorder for non-motion events.

### CROSS REFERENCE TO RELATED APPLICATIONS

This application claims the benefit of Provisional Patent Application Ser. No. 112948 U.S. PTO 60/840185 issued Aug. 25, 2006 by the present inventor, which is incorporated by reference.

### STATEMENT OF FEDERALLY SPONSORED RESEARCH/DEVELOPMENT

There were no federal expenditures or sponsorships of this research or development.

### SPECIFICATION

1. Field of the Invention

This invention pertains to the field of video recording of exceptional events.

2. Background and Description of Current Solutions

There exists a product commonly referred to as text inserter used to insert into video, typically from a closed circuit television camera, a data stream usually in the form of text. It should be noted that the inserted video is not exclusively text but may also includes graphical icons and borders, but for brevity is referred to as text. A classical application for text inserters is in a Point of Sale environment where a major goal for business owners is reduction of employee theft. Employee theft occurs in the form of voiding a transaction or refunding part of the charge for a product or removing cash from the drawer. In the typical application, a text inserter connects to a cash register, a video camera and a video recording device. The text inserter captures data such as from a pole display interface or a receipt printer interface or a special text inserter interface of the cash register. This captured data is transformed into a text or graphic overlay onto video. Video typically comes from a closed circuit television camera. However, video from a camera is not required as a self-generated video with only the text is also possible. The resulting video with overlay can be observed in real time and can be recorded for later reference. The resulting video with inserted text is useful to the business owner for discouraging fraud and detecting fraud when it occurs. However, the reviewing of live or recorded video can be time consuming. Some text inserters have been developed to work with video recording devices to flag special exception events by several methods. First, by highlighting the text associated by these events or by causing the text to blink. Second, by triggering recording of these events using a dedicated electrical circuit connection. Third, by incorporating into the video recorder the necessary processing of the data for keywords associated with exceptional events and developing a database of the time the events occur. In a Point of Sale example, these exceptional events are cash register actions that are typically associated with a greater likelihood of fraudulent activities. Events such as the keywords “VOID”, “NO SALE, “REFUND” and “OPEN CASH DRAWER”. The first three are examples of such register actions in the English language. In the case of “OPEN CASH DRAWER”, this is a common non-English data event. The open cash drawer event occurs when the cash register sends a code to a peripheral such as a printer, which drives a relay causing the cash drawer to open.

The first and second methods are realized as stand-alone text inserters. They are separate from the video recording device and which provide for an electrical signal to trigger a typical “alarm” input on video recorders. The third method provides excellent integration and requires no additional wiring for the electrical signal. Software within the system controls recording.

Prior Art, Motion Detection

There exists video motion detections system designed to capture intrusion events by triggering on qualified motion within a video image. At least as far back as 1973, U.S. Pat. No. 3,740,466 describes such a system. To prevent unwanted triggering of recording, systems have been developed where the user can mask portions of the image against motion detection. U.S. Pat. No. 6,097,429 describes such a system for masked intrusion detection. However, U.S. Pat. No. 6,097,429 does not envision any connection to a data domain such as a point of sale system and the triggering of recording by simulating motion on the occurrence of an exception event such as a suspicious cash register activity. U.S. Pat. No. 6,069,655 describes similarly limited motion detection systems. U.S. Pat. No. 5,842,978 describes a medical system where audio and video are combined with data as on overlay, and further a means is provided to index the recorded audio video image with an alarm signal for managing the recording or indexing. However, the alarm signal is carried by a separate wire connection, not by simulating motion.

Prior Art, Text Inserters

Existing text insertion products have method(s) to flag exception events by various techniques of highlighting the inserted text. Highlighting can include methods such as color, blinking, reversing the text and background, adding a color background to the text characters. This method scatters the flag around on the video display. This scatter of locations is not friendly for real time or recorded review of the video for keywords.

Also, there exist systems with discrete electrical outputs. These output an electrical signal to the recording device and which are connected to the recording device inputs. These inputs are typically known as Alarm inputs. These outputs transform the data event into alarm events and therefore trigger recording of video. These systems do not envision or use simulated video motion to trigger recording of exception events. Additionally, the number of alarm interfaces is fixed by the number of electrical connections provided. Reference “American Video Equipment” web site: http://www.americanvideoequipment.com/catalog/cashRegisterOverview.htm which says in part, “The EX function gives you 2 hard alarm outputs to trigger alarming VCR's, Quads, or other alarming devices for Exception reporting allowing easy review of exceptional sales, or Instant reviewing on DVRs.” Our solution, simulation motion, using the Text Inserter text can provide numerous, flexible number of alarms for a numerous and flexible number of keywords.

Prior Art, Integrated Text Inserter and DVR

Well integrated video surveillance systems exist which builds a database of exception events for reviewing recorded video or for starting and stopping recording the video. Such a digital video recorder or DVR system can even integrate Point of Sale functions. Such a system, as described by U.S. Pat. No. 7,015,945 for instance, has among its modes of operation a mode where files “includes data and video in the digital file, the second mode associated with an exception condition of the financial transaction”. However, this patent describes a fully proprietary system. It is fundamental to this systems operation that no motion-sensing algorithm is necessary for building the database of events by this system. This is because the system has direct access to the data and a processor for evaluating logical states. Such systems provide no support for legacy video recorders having no such data input and processing capability.

### STATEMENT OF OPPORTUNITY

There exist text insertion systems for flagging events in the data domain for which it is desired to review associated video images. These systems can identify keywords or states in the data. Simple systems assert an electrical alarm signal or flag keywords by highlighting the inserted text, and better systems create a list or database of key events integrated with the video recording system for selective playback. However, there is a large installed base of cash registers and video recording systems in place without data integration or available alarm inputs or without an easy way to wire the alarm inputs to a stand-alone text inserter.

Many DVRs have motion sensing to trigger recording. Many build databases of triggered events. A way is needed to build a database where motion is not a natural trigger. A way is needed to avoid the cost of replacing the large installed base of DVRs to enable triggering on data events. A way is needed to avoid the cost of design changes to new DVR systems to add a data input to trigger recording. The invention described in this application does just that.

### SUMMARY OF THE INVENTION

The invention is a text or graphics video, overlay device. The device examines data for exception states or events. The device used logical combinations of a single or multiple data elements to determine a state or states. The device visually flags exception events and simulates video motion to trigger video recording in a motion sensitive video recorder. The desired recording is thus initiated by non-motion events. By inserting flags into a predetermined location in a video image, both a human viewer and a motion sensitive recorder can detect the data exception event. By protecting the predetermined flag location against motion by inserting a static background, the unrelated motion of the video image is masked to exclude competing motion of the closed circuit camera image. The human eye and motion sensitive recorders can thus more easily differentiate the inserted flag and motion recording can be limited to the exception event. Further, it becomes a requirement that the location of the area of the motion sensing and the location of the area of the inserted, protected, flags can be made to coincide by design or adjustments within the text inserter, the video recorder or both. In the most general implementation, the invention is a general transducer from a data state domain into a video image suitable for human visual review and to triggered recording on video recorder(s) employing motion-sensing recording. The device may mask portions of the video image against motion to seclude the motion of the inserted text by excluding background motion events in the image. Further, even for legacy systems without motion sensing, if the text inserter places an event label into the recorded video at a predefined location, and such location can be different for the different trigger events, the business owner can fast review the recorded events at high speed, pausing only on the type of transaction of interest.

Non-motion events can occur in numerous data domains listed here, but are not limited to: the transaction messages of a point of sale cash register, the lock or un-lock condition of a safe, the crossing of a temperature threshold, an equipment in-service message, an equipment in-motion message, and equipment failure warning or similar.

A variation is to use a feature in many text insertion integrated circuits. Such integrated circuits generate a picture border or frame around the perimeter of the so-called safe caption area of the video. The safe caption area is a subset of total video area that should never be hidden behind the bezel of even the worst-case television used as a monitor. The text inserter can change this border to signal exception data events and trigger recording. The simulated motion is created by changing the color or brightness of the frame. This would preserve more of the active safe caption text insertion area for actual text insertion.

### DRAWING DESCRIPTIONS

FIG. 1 is a diagram of the interconnection of the proposed system.

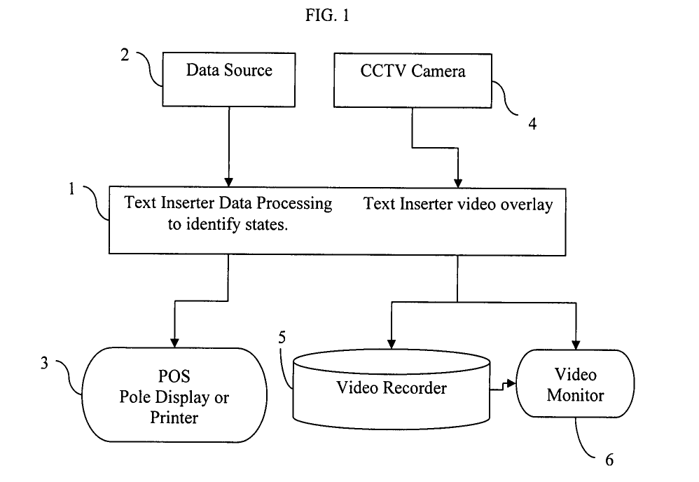

FIG. 2 is a diagram of the video image showing the protected area of video and example of inserted video overlay of text.

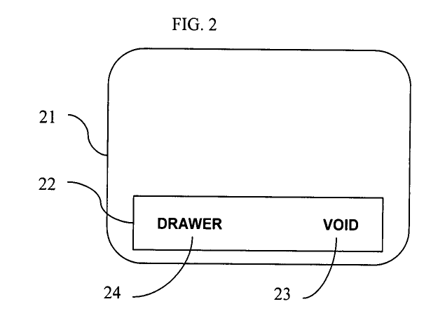

FIG. 3 is a flow chart of the software in the text inserter.

FIG. 4 is a diagram of the video image showing the use of a border or frame around inserted text.

### DETAILED DESCRIPTION OF THE INVENTION AND THE PREFERRED EMBODIMENT

The text inserter 1 receives data such as transaction data from a cash register or Point of Sale (POS) system 2. The transaction data is passed unaltered on to the peripheral such as a pole display or receipt printer 3. The text inserter 1 receives video from a camera 4. Video from the text inserter is sent to a recording device 5 and may be sent to a monitor 6. The text inserter 1 processes the data to find keywords or control codes or combinations of keywords and control codes to determine a state. When an exception state occurs, the inserted text is modified to reflect the event. Within the active video on the monitor 21 the user can see a blanked out protected area of video 22. Since there is no image content from the camera in this area 22, no motion will be present due to any activity in the field of view of the camera.

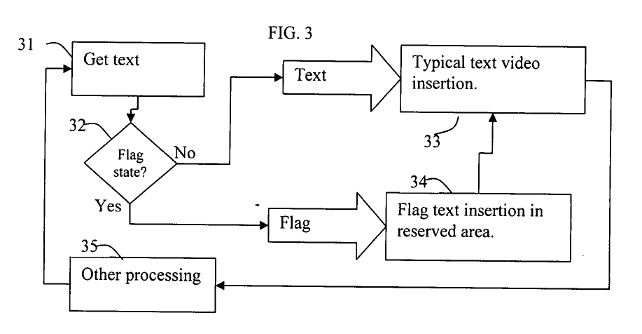

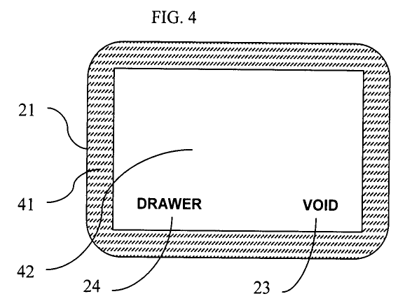

In the preferred embodiment, the text inserter reserves a location within the video image by blanking out an area 22. Motion is simulated to trigger recording by inserting text 23 or 24. This temporal change by overlay of text will be interpreted as motion by the video recorder 5 with area motion sensing and can be seen easily by the user. The user can review the video in real time, or at high-speed, to locate the type of transaction such as “void” 23 or “cash drawer open” 24 events. FIG. 3. shows the software in the text inserter 1 is composed of a main loop, which gets text 31 from the data input or inputs. The text is tested 32 to see if it is to be flagged as an exception event. If not, it is inserted normally 33. If the data state meets the condition(s) to be flagged, a text or graphic is inserted in the reserved area of the screen 34. The text is then also inserted normally 33. Other processing 35 continues with system functions such a clearing the screen of inserted text after a period of inactivity. The words used to flag an exception event 23 or 24 may be different for the particular application. For instance, an ATM might flag a cash withdrawal over a certain amount. FIG. 4. shows how a simulated motion may also be created by changing the border or frame 41 around the normal video and Text Insertion area 42.

### CONCLUSION , RAMIFICATIONS AND SCOPE

Accordingly, the reader will see that, according to the embodiment of the invention, I have provided a new useful bridge from the domain of any data, which can have exception events, to a motion sensitive video recorder. While the above description contains many specifics, these should not be construed as limitations on the scope of any embodiment, but as exemplifications of the present preferred embodiments thereof. Many other ramifications and variations are possible within the teachings of the various embodiments. For example, Point Of Sale applications typically present the video overlay device with digital data. This need not be the case. The video overlay device might sample an analog signal or signals representing a data domain. The video overlay device would then be programmed with a threshold or thresholds for an exceptional condition and the video overlay device will then subsequently insert text flagging the event and simulating motion to trigger recording. Thus, the scope of the invention should be determined by the appended claims and their legal equivalents, and not by the examples given.

What is claimed is:

1. A video text insertion device comprising a means for input from a data domain, a data processor, and a means of video text or graphic overlay, the data processor searching the input data for symbols, keywords, or logical combinations of symbols and keywords to determine a state and on certain states causing the video overlay of inserted video text or graphic. Said overlay to be in a predefined location of the video image. Said overlay to simulate motion and therefore to triggering recording of video by a motion sensitive recording device.

2. A device of claim 1, which triggers recording of video by simulating motion in an area of video which said device self reserves by masking the normal video.

3. A device of claim 2, with a multiplicity of reserved areas in the video image to trigger recording of video.

4. A video text insertion device comprising a means to input from a data domain such as from a cash register, a data processor, and a means of video text or graphic overlay, the data processor searching the input data for symbols, keywords or logical combinations of symbols and keywords to determine a state and on certain states causing the video overlay of inserted video text or graphic in a fixed visible location to appear as an easy to see visual indication of the exception event.

5. A device of claim 4, with a multiplicity of reserved areas in the video image to indicate visually the exception events.

6. A video text or graphic insertion device comprising a means to input from a data domain such as from a cash register, a data processor, and a means of video text overlay surrounded with a background of a solid border or frame which is programmable in brightness or color, the data processor searching the input data for symbols, keywords, or logical combinations of symbols and keywords to determine a state and on certain states causing the video overlay to change the brightness or color of the border or frame, or a portion of a border or frame, of an image as an indication of the exception event.

7. A device of claim 6 where the border or frame consists of more than one region of solid brightness or color, which can be changed under program control.

8. A device of claim 6 where the border or frame, which has continuously varying spatial brightness or color which, can be changed under program control.
